(19) United States
(12) Patent Application Publication
(10) Pub. No.: US 2009/0225832 A1
(43) Pub. Date: Sep. 10, 2009

(54) Error concealment technique for inter-coded sequences

(75) Inventors: Cristina Gomila, Princeton, NJ (US); Jill Macdonald Boyce, Manalapan, NJ (US)

Correspondence Address: Thomson Licensing LLC, P.O. Box 5312, Two Independence Way, PRINCETON, NJ, 08543-5312, US

(73) Assignee: Thomson Licensing, Boulogne-Billancourt (FR)

(21) Appl. No.: 11/658,482

(22) PCT Filed: Jul. 29, 2004
(86) PCT No.: PCT/US04/24745

§ 371 Date: Jan. 25, 2007

(51) Int. Cl. H04N 7/26

(52) U.S. Cl. 375/240.12; 375/240.25; 375/240.16; 375/E07.246; 375/E07.123

(57) ABSTRACT

Using different error concealment techniques for coded pictures that undergo display and those that undergo storage as a reference picture improves the quality of error concealment. A concealment technique optimized for use in real time will provide the best visual quality for pictures that undergo display whereas a concealment technique optimized to recover lost data improves the quality of stored reference pictures.

### TECHNICAL FIELD

This invention relates to a technique for concealing errors in a coded picture.

### BACKGROUND ART

In many instances, video streams undergo compression (coding) to facilitate storage and transmission. Presently, there exist a variety of coding schemes, including block-based schemes such as the proposed ISO/ITU H.2.64 coding technique. Not infrequently, such coded video streams incur data losses or become corrupted during transmission because of channel errors and/or network congestion. Upon decoding, the loss/corruption of data manifests itself as missing/corrupted pixel values that give rise to picture artifacts. To reduce such artifacts, a decoder will “conceal” such missing/corrupted pixel values by estimating the values from other macroblocks of the same picture or from other pictures. The phrase error concealment is a somewhat of a misnomer because the decoder does not actually hide missing/corrupted pixel values.

Spatial concealment seeks to derive (estimate) the missing/corrupted pixel values from pixel values from other areas in the same picture relying on the similarity between neighboring regions in the spatial domain. Temporal concealment seeks to derive the missing/corrupted pixel values from other pictures having temporal redundancy. In general, the error-concealed picture will approximate the original picture. However, using an error-concealed picture as reference will propagate errors. Present-day real-time applications impose two hard constraints for error concealment:

A time constraint, obliging the computation of the concealment in a time window that defines the interval between error detection and display for the corrupted frame; and

A causal constraint, obliging concealment of pictures based on previously transmitted information, despite incoming information in the bit-stream potentially relevant for concealment.

Both constraints strongly limit the performance of the concealment algorithms and increase error propagation.

The problem of error propagation differs depending on the use of concealed pictures for display as well as for subsequent reference. When a concealed picture is a displayable picture, not used as reference, concealment inaccuracies never compromise the quality of other inter-coded pictures. However, results are needed in real-time. When a concealed picture is used as reference picture, errors often propagate and become visible because of their time persistence. However, the real-time constraint will not limit the complexity of algorithms associated with deriving reference pictures from concealed pictures. Reducing error propagation has typically been addressed as a problem of error resiliency. The most common error resiliency techniques require the inclusion of redundancy bits in the transmitted stream and make use of a feedback channel for the retransmission of lost or damaged packets, at the expense of coding efficiency and increasing time delays.

For applications that do not support the time and causal constraints, an error concealment algorithm becomes necessary for correcting the transmission errors at the decoder. Under such circumstances, error propagation will depend on the quality of concealment on the reference pictures. Heretofore, preventing error propagation required avoiding the use of previously concealed blocks as a reference. However, such a technique does not address the problem of error propagation, depending on whether the corrupted picture will serve as a reference or required only for display.

Thus, a need exists for a technique that improves the quality of error concealment while overcoming the aforementioned disadvantages.

### BRIEF SUMMARY OF THE INVENTION

Briefly, in accordance with a preferred embodiment of the present principles, there is provided a method for concealing errors in a coded picture. The method commences by first identifying whether the coded picture has an error. If so, then the picture is concealed using a first concealment technique for display. A determination is made for the picture identified as having an error, whether that picture will serve as a reference picture. If so, the picture is concealed using a second concealment technique.

### BRIEF DESCRIPTION OF THE DRAWINGS

FIG. 1 depicts a block schematic of a decoder for performing error concealment in accordance with the present principles;

FIG. 2 depicts in flow chart form the steps of a method in accordance with a first preferred embodiment of the present principles for concealing displayable and stored (reference) pictures;

FIG. 3 depicts in flow chart form the steps of a method in accordance with a second preferred embodiment of the present principles for concealing displayable and stored pictures;

FIG. 4 depicts a group of pictures illustrating how time-recursive concealment can improve the quality of inter-prediction; and

FIG. 5 depicts in flow chart form the steps of a method in accordance with a third preferred embodiment of the present principles for concealing displayable and stored pictures.

### DETAILED DESCRIPTION

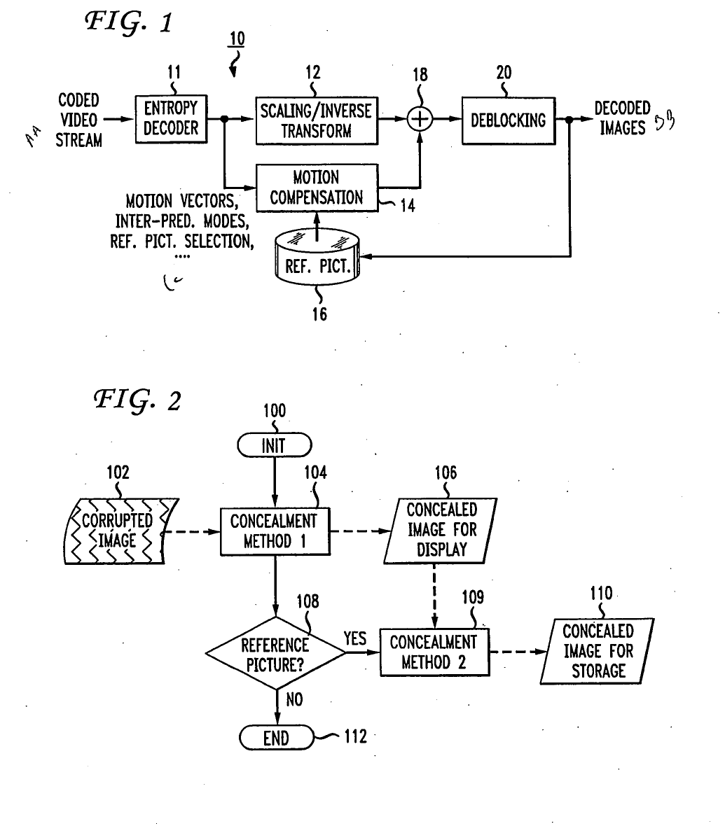

FIG. 1 depicts a block schematic diagram of a decoder arrangement 10 for decoding coded pictures. The decoder arrangement 10 includes an entropy decoder 11 that produces a decoded video stream for input to a scaling and inverse transformation block 12. In accordance with the incoming coded video stream, the entropy decoder 11 produces a set of motion vectors, a designation of inter-prediction modes, as well as selection of one or more reference pictures for input to a motion compensation block 14 which performs motion compensation using one or more previous stored reference pictures stored in a reference picture store 16. A summing block 18 sums the motion-compensated picture produced by the motion compensation block 14 with the picture from the scaling an inverse transformation block 12. A deblocking filter 20 de-blocks the picture output by the summing block 18 to yield a decoded image for display. The decoded image output by the deblocking filter 20 also undergoes storage in the reference picture store 16 for later possible use as a reference picture.

All coded pictures input to the decoder arrangement 10 ultimately undergo display, but only some of them are used for reference. When the incoming video stream received by the entropy decoder 11 has been compressed using the H.264 compression standard, the nal_ref_idc field in the NAL header of each picture coded will indicate if a picture will serve as a reference picture or not. The entropy decoder 11 will use such information to decide whether or not a particular picture will serve as a reference picture. If nal_ref_idc equals zero, the picture will not serve as a reference. If nal_ref_idc does not equal to 0, the picture can serve as reference picture.

FIGS. 2, 3 and 5 each depict, in flow chart form, alternate methods for performing error concealment in accordance with the present principles. As described in greater detail hereinafter, the error concealment method depicted in FIGS. 2, 3, and 5 make use one technique for display pictures, and a different technique for those pictures selected as reference pictures. Using an error concealment technique specific for display pictures provides the best visual quality under the real-time constraint, whereas using an error concealment technique specific for reference pictures allows for more accurate recovery of lost data. Since all coded pictures undergo display, such pictures can undergo concealment using a technique specific for display, whereas only those pictures selected as reference pictures undergo concealment using a technique specific for reference pictures whereas . . . ” FIG. 2 depicts a first concealment method in accordance with the present principles, whereby error concealment of display pictures occurs by a first technique, and error concealment of reference pictures occurs by combining (i.e., chaining) the first technique with a second concealment technique. The concealment method of FIG. 2 commences upon execution of an initialization step (step 100) during which by various process parameters undergo initialization. Next, step 102 occurs during which an incoming macroblock undergoes examination to detect if errors are present in the form of missing or corrupted pixel values. Upon finding an error-containing macroblock, error concealment occurs during step 104 using a first concealment technique to yield a concealed image 106 for display. During step 108, a determination then occurs whether the macroblock concealed during step 104 represents part of a picture that will serve as a reference picture. If so, the image 106 previously concealed during step 104 undergoes further concealment during step 109 via a second concealment technique to yield a concealed image that undergoes storage for subsequent reference. If the determination performed during step 108 finds that the picture represented in part by the incoming macroblock will not serve as a reference picture, then the process ends during step 112.

The concealment process depicted in FIG. 2 makes use of the image 106 obtained after concealment during step 104 as the input to the concealment that occurs during step 109. In this way, the concealment performed during step 109 becomes “chained” to the concealment performed during step 104. The method of FIG. 2 provides a simple and fast solution for real-time display of the concealed image 106, which then undergoes further concealment to yield a better prediction for a stored reference picture.

The choice of concealment techniques performed during steps 104 and 109 will depend the desire to achieve temporal or spatial error concealment. For example, for temporal error concealment, the error concealment performed during step 104 will fill out missing/corrupted regions by searching for the best match among a reduced number of motion vectors, whereas the concealment performed during step 109 enlarges the search area or the number of tested displacements. A similar approach could be implemented for spatial error concealment. Under such circumstances, the error concealment performed during step 104 will test only the most-used intra-prediction modes, while the concealment performed during step 109 matches the remaining modes to improve the quality of the reconstructed data.

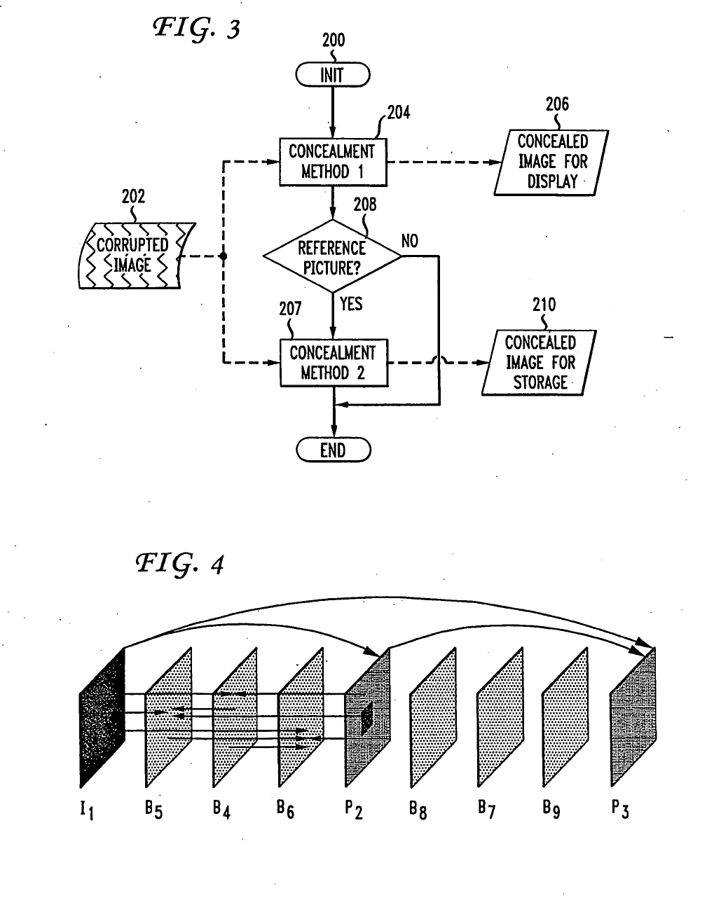

FIG. 3 depicts a second concealment method in accordance with the present principles, whereby concealment of an error-containing macroblock occurs by use of different error concealment techniques for display pictures and stored (reference) pictures in parallel. Because error concealment techniques performed to obtain the best subjective visual quality do not always provide the best reference picture for inter-prediction of later pictures, a clear benefit exists in utilizing two different concealment strategies.

The concealment method of FIG. 3 commences upon execution of an initialization step (step 200) during which by various process parameters undergo initialization. Next, step 202 occurs during which an incoming macroblock undergoes examination to detect errors. Upon finding an error-containing macroblock, error concealment occurs during step 204 using a first concealment technique to yield a concealed image 206 for display. During step 208, a determination then occurs whether that same incoming macroblock represents part of a picture that will serve as a reference. If so, the incoming macroblock undergoes concealment during step 209 using a second concealment method to yield an error-concealed image 210 that undergoes storage for subsequent reference. If the determination performed during step 208 finds that the picture associated with the incoming macroblock will not serve as a reference picture, then the process ends during step 212.

The concealment process depicted in FIG. 3 utilizes separate concealment techniques in parallel. For example, in the case of large missing regions, a displayed picture will appear perceptually better by concealing the whole picture while discarding correctly received macroblocks to avoid visible artifacts at the transitions. However, the prediction of inter-coded macroblocks using a concealed picture as reference requires precise data reconstruction while artifacts created on the macroblock edges have little or no importance. Under such circumstances, using a concealment technique specific to a display picture will increase the quality of display while using a concealment technique specific to reference pictures will reduce error propagation for inter-prediction.

While the previous examples illustrate the benefits of having different concealment strategies for display and reference pictures, a benefit also exists in making use of concealment techniques of different complexity. With regard to the use of previously transmitted data, the real-time constraint and the causality constraint mainly affect the concealment of displayable pictures and, to a lesser extent, the concealment of stored pictures for reference. Note that when processing stored pictures for reference, the time window for performing concealment extends to the time when the stored pictures become used as references, which is typically longer than the time for display.

As described in greater detail hereinafter, recursive error concealment, by making use of later transmitted pictures, can increase the quality of a previously decoded picture. To illustrate the advantages of such a technique, assume for purposes of discussion that errors exist which would give rise to the picture sequence as depicted in FIG. 4, which has decoding order of I₁ P₂ P₃ B₄ B₅ B₆ B₇ B₈ B₉, whereas the display order is I₁ B₅ B₄ B₆ P₂ B₈ B₇ B₉ P₃. In the event that corrupted macroblocks were found in the picture P₂, error concealment applied to such macroblocks in real-time during the decoding of this picture would require reliance on the information from picture I₁. However, since the picture P₂ appears 5th in the display and not 2nd, error concealment could improve the predicted results by using information from a forthcoming picture, as P₃, for example. In case corrupted blocks were found on a B frame, this technique could provide useful only if display did not occur immediately after decoding.

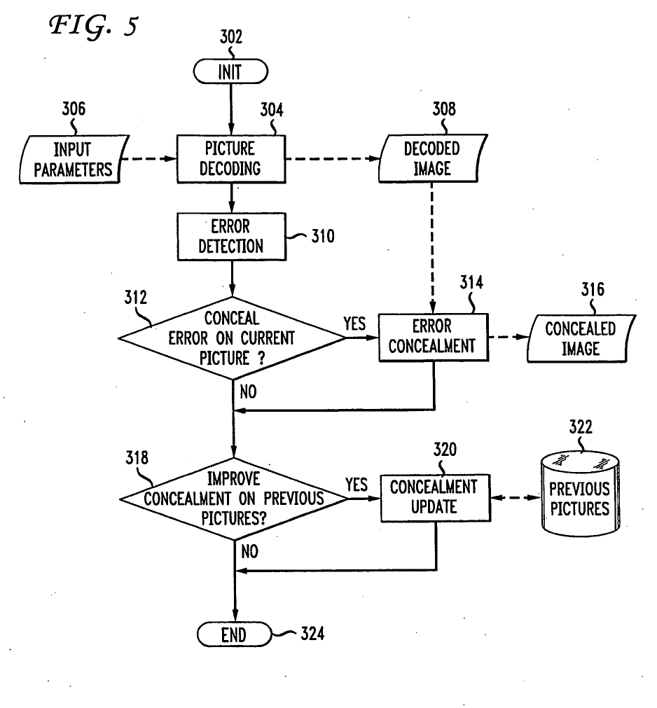

FIG. 5 depicts a concealment method that employs a time-recursive technique to obtain quality improvement for images previously concealed using the methods of FIGS. 2 or 3. The method of FIG. 5 commences upon execution of an initialization step (step 300) during which by various process parameters undergo initialization. During step 302, decoding of the picture contained in the incoming macroblock 304 occurs, thus yielding a decoded image 308. During execution of Step 310, error detection occurs. Upon finding an error during step 312, a determination occurs during step 312 whether to conceal such an error in the current picture. If so, then error concealment occurs during step 314, yield a concealed image 316. If no error concealment is desired, then step 318 occurs and a determination is made whether to improve the error concealment of any previous picture. If so, then the error concealment of such previous picture undergoes updating during step 320 using the previously concealed pictures 322 as inputs to the concealment process. Following step 320, or following step 318 if no improvement on the concealment of any previous picture should prove necessary, then the process ends during step 324. Note that steps 318 and 320 could be performed recursively over time to continuously improve error concealment.

The foregoing describes a technique for improving the quality of inter-coded sequences by employing different concealment techniques for display and reference pictures.

1. A method for concealing errors in a coded picture upon decoding, comprising the steps of:
identifying whether the picture has an error and if so,
concealing the picture using a first concealment technique for display
determining whether the picture having the error will serve as a reference picture, and if so,
concealing the picture using a second concealment technique.

2. The method according to claim 1 wherein the step of concealing the picture using the second concealment technique enhances the concealment achieved by the first concealment technique.

3. The method according to claim 2 wherein the second concealment technique is performed recursively over time to improve quality of a previously decoded picture.

4. The method according to claim 1 wherein the second concealment technique is performed recursively over time to improve quality of a previously decoded picture.

5. The method according to claim 1 wherein the first and second concealment techniques are performed in parallel.

6. The method according to claim 1 where the first and second concealment techniques each achieve temporal concealment.

7. The method according to claim 1 where the first and second concealment techniques each achieve spatial concealment.

8. The method according to claim 6 wherein the step of concealing the picture using the first concealment technique further comprises the step of searching for a best match among a reduced set of motion vectors obtained during picture decoding.

9. The method according to claim 8 wherein the step of concealing the picture using the second concealment technique further comprises the step of enlarging a search area to search among an increased set of motion vectors.

10. The method according to claim 7 wherein the step of concealing the picture using the first concealment technique further comprises the step of testing only a set of most-used intra-prediction modes obtained during picture decoding.

11. The method according to claim 11 wherein the step of concealing the picture using the second concealment technique further comprises the step of matching all untested intra-prediction modes.

12. A method for concealing errors in a coded picture undergoing decoding, comprising the steps of:
identify whether the picture has an error and if so,
determining, whether picture having an error will serve as a reference picture, and if so then
concealing the picture using a technique specific for a reference picture, and
concealing a picture not serving as a reference picture using a technique specific for displayed pictures.

13. The method according to claim 12 where the first and second concealment techniques each achieve temporal concealment.

14. The method according to claim 12 where the first and second concealment techniques each achieve spatial concealment.

15. The method according to claim 13 wherein the step of concealing the picture using the first concealment technique further comprises the step of searching for a best match among a reduced set of motion vectors obtained during picture decoding.

16. The method according to claim 15 wherein the step of concealing the picture using the second concealment technique further comprises the step of enlarging a search area to search among an increased set of motion vectors.

17. The method according to claim 14 wherein the step of concealing the picture using the first concealment technique further comprises the step of testing only a set of most used intra-prediction modes specified during picture decoding.

18. The method according to claim 17 wherein the step of concealing the picture using the second concealment technique further comprises the step of matching all untested intra-prediction modes.

19. A method for concealing errors in a coded picture during picture decoding, comprising the steps of:
detecting if an error is present in said picture,
determining whether to perform error concealment based on the detected error, and if so,
performing error concealment using a first concealment technique;
determining whether error concealment of the picture can be improved, and if so, then
updating error concealment of the pictures using at least one previously concealed picture.

20. A method for concealing errors in a coded picture upon decoding, comprising the steps of:
identifying whether the picture has an error and if so,
determining whether the picture having the error will serve as a reference picture, and if so,
concealing the picture using a concealment technique specific for reference pictures.
